(19) United States
(12) Patent Application Publication
(10) Pub. No.: US 2003/0047001 A1
(43) Pub. Date: Mar. 13, 2003

(54) Ball speed detecting assembly

(76) Inventor: Grace Liao, Hsinchu (TW)

Correspondence Address: BROWDY AND NEIMARK, P.L.L.C., SUITE 300, 624 NINTH STREET, N.W., Washington, DC, 20001-5303, US

(21) Appl. No.: 09/939,981

(22) Filed: Aug. 28, 2001

(51) Int. Cl. G01P 3/18; G01P 1/02

(52) U.S. Cl. 73/493; 73/530; 340/384.5

(57) ABSTRACT

A ball speed detecting assembly has a detecting device consisting of a bracket adapted to firmly stand on the ground and having an opening; a net securely connected to the bracket to cover the opening; an impact receiving element securely connected to the bracket by sensors which are secured to corners of the bracket so that the sensors are able to detect the impact of the ball which hits the impact receiving element; and a displaying device consisting of a microprocessor electrically connected with the sensors and having data prestored in the microprocessor for matching the impact of the ball; and at least one speaker electrically connected with the microprocessor for sounding according to a signal from the microprocessor.

### FIELD OF THE INVENTION

The present invention relates to a ball speed detecting assembly, and more particularly to a detecting assembly that is able to detect the speed of a ball. The assembly has detecting sensors each secured to a corner of a receiving area for sensing the pressure on the receiving area and a net provided to catch the ball.

### BACKGROUND OF THE INVENTION

Ball speed of the ball team sometimes becomes the sole factor for wining. Based on the reason, when a ball team is practicing, whoever controls the speed of the ball focuses on the practice of the increase in ball speed. In order to detect the ball speed, the existing device is a detecting gun which places beside the trajectory of the ball so that when the ball passes through the detecting gun, the detecting gun detect the speed of the ball. However, the practice of increasing the ball speed often needs more than two players to accomplish the goal, one shoots the ball and one detect the ball and sometime a third one is required to receive the ball. In other words, the detecting gun is not able for a single player to accomplish the goal alone, which is quite troublesome and labor inefficient.

To overcome the shortcomings, the present invention intends to provide an improved ball speed detecting assembly to mitigate or obviate the aforementioned problems.

### SUMMARY OF THE INVENTION

The primary objective of the invention is to provide a ball speed detecting assembly, with which the player is able to detect the speed of the ball.

Another objective of the invention is to provide a ball speed detecting assembly having a net so that the ball is collected after each shot.

Other objects, advantages and novel features of the invention will become more apparent from the following detailed description when taken in conjunction with the accompanying drawings.

### BRIEF DESCRIPTION OF THE DRAWINGS

FIG. 1A is a perspective view of the training device of the present invention;

FIG. 1B is a side view of the training device of FIG. 1A;

FIG. 2 is a perspective view of the training device of FIG. 1 with a microprocessor to process data received;

FIG. 3A is a perspective view of the training device of another preferred embodiment of the present invention;

FIG. 3B is a side view of the embodiment of FIG. 3A;

FIG. 4 is a perspective view of the embodiment of FIG. 3A with a microprocessor to process data received; and

FIG. 5 is a perspective view of the training device of the present invention with vibration sensors provided on the net.

### DETAILED DESCRIPTION OF THE INVENTION

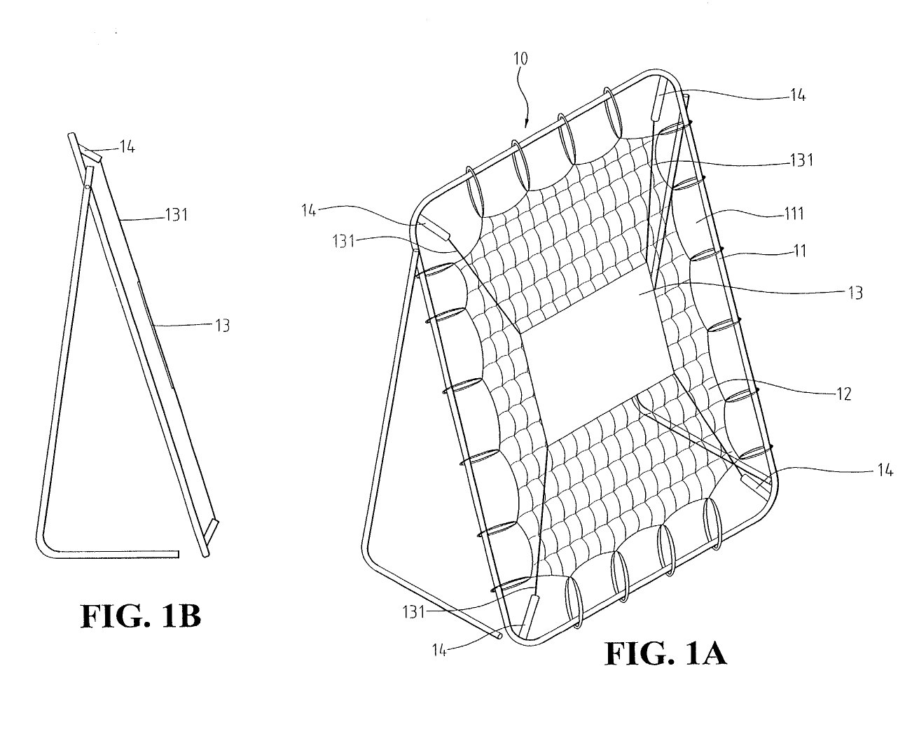

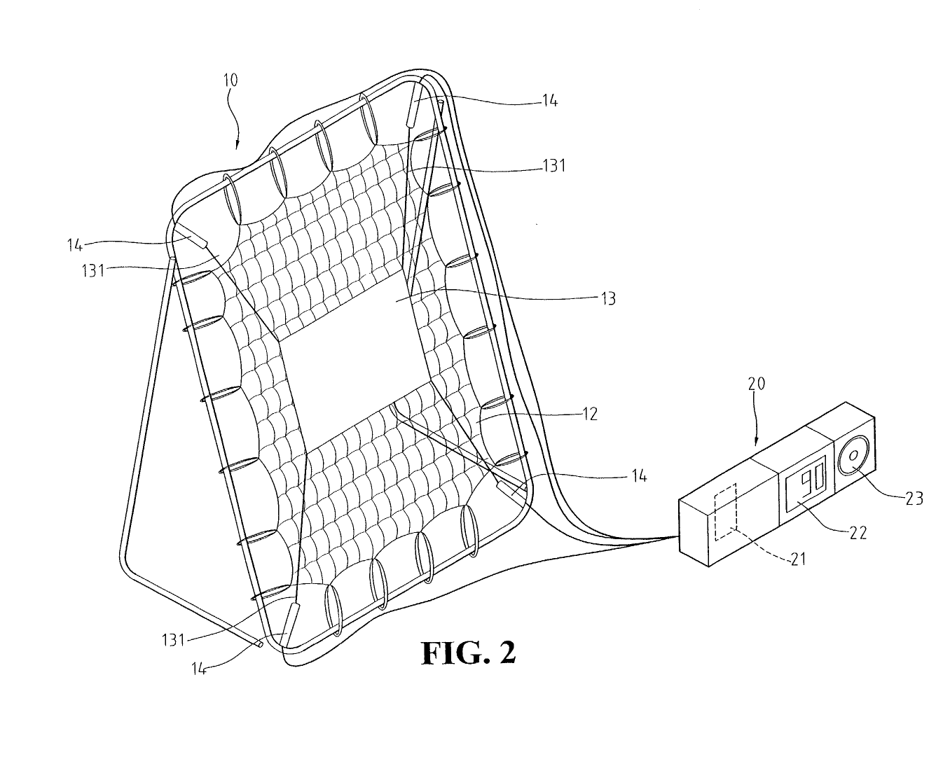

With reference to FIGS. 1A, 1B, and 2, the ball speed detecting assembly in accordance with the present invention has a detecting device (10) and a displaying device (20).

The detecting device (10) includes a bracket (11), a net (12), an impact receiving element (13) and sensors (14).

The bracket (11) is able to stand on the ground and has an opening (111). The net (12) is securely connected to the bracket (11) and covers the opening (111) of the bracket (11). The impact receiving element (13), preferably a resilient sheet such as a fabric, is secured to the bracket (11) by means of thread (131) and the sensors (14), wherein the sensors (14) are placed on corners of the bracket (11) (four are shown in the embodiment).

The displaying device (20) includes a microprocessor (21) and a display (22) connected to the microprocessor (21). The microprocessor (21) stores information concerning data of pressures of the balls with different speeds impacted on the impact receiving element (13). For example, when the ball speed is 90 km/hr, the corresponding pressure to the ball with 90 km/hr speed is 30 lb/in. The information of such experiment is stored in the microprocessor (21).

When the assembly is in use, the player throws the ball with a certain speed and when the ball hits the impact receiving element (13), the sensors (14) detect the pressure on the impact receiving element (13) caused by the impact of the ball to the impact receiving element (13) and then transmit the pressure to the microprocessor (21) for matching with the data. When the detected pressure matches a certain data inside the microprocessor (21), the microprocessor (21) will then send out a signal and a prerecorded voice will indicate the speed of the ball. After each practice, the ball is able to be picked up by the net (12) such that the user is able to accomplish the practice alone without any assistance from other players.

However when the ball impacts the area other than the impact receiving element (13), such as the net (12), because the ball is able to be collected by the net (12), the rolling of the ball inside the net (12) causes continuous change of pressure and this continuous change in pressure will be picked up by the sensors (14) as well, which triggers the microprocessor (21) to send out a signal to initiate the speaker (23) to indicate that this throw is invalid.

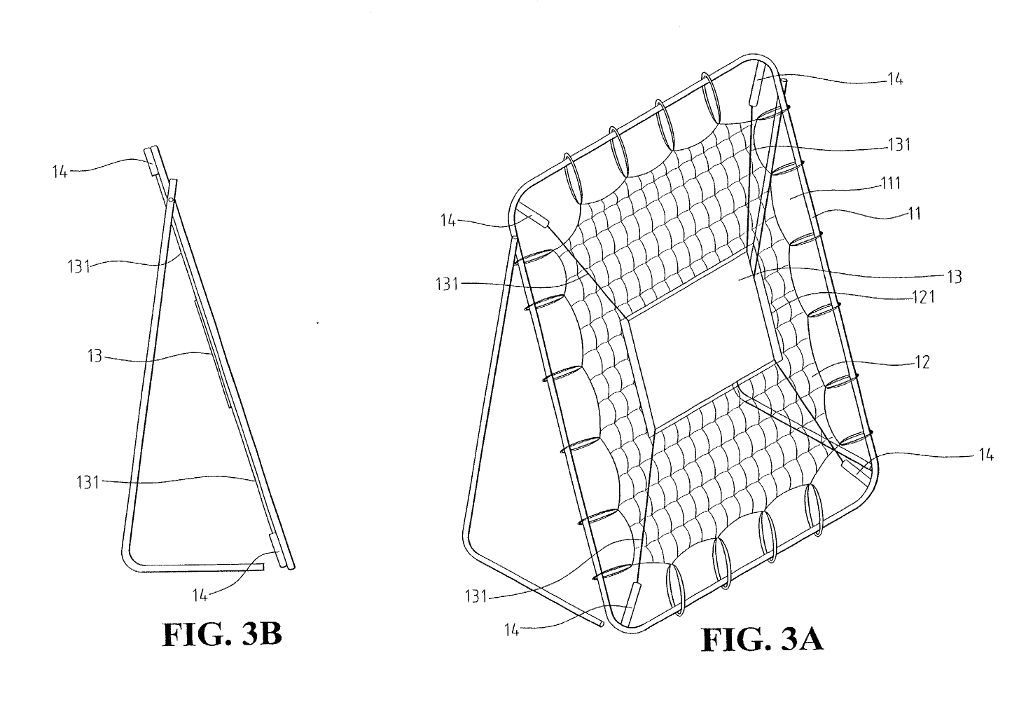

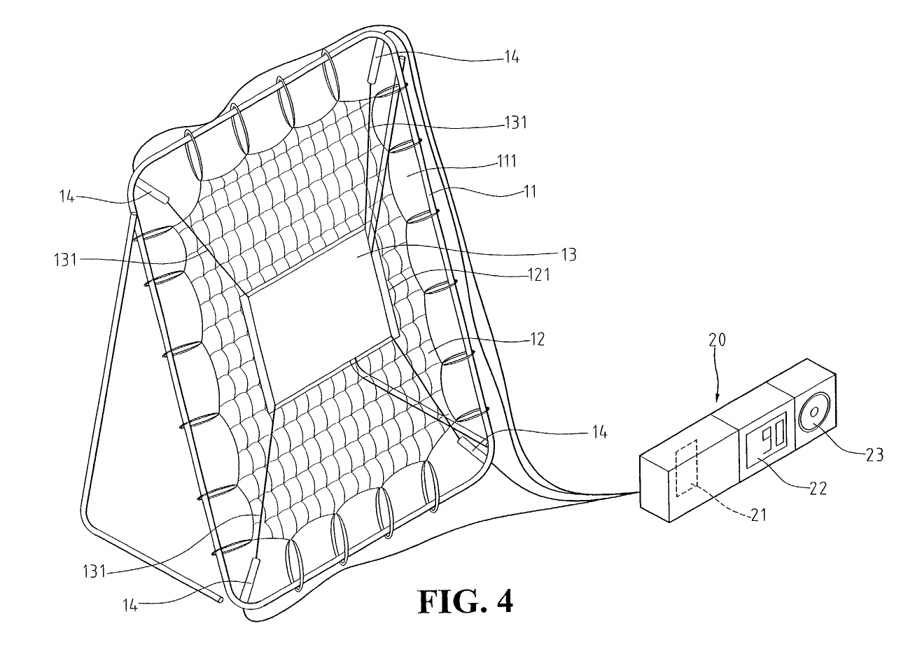

With reference to FIGS. 3A, 3B, 4 and taking FIG. 1B for reference, it is noted that the net (12) together with the impact receiving element (13) in FIG. 1B is mounted in front of the bracket (11) and the impact receiving element (13) in FIGS. 3A or 3B is in the rear of the bracket (11), which causes the impact receiving element (13) in FIGS. 1A and 1B is also mounted in front of the bracket (11) and the net (12) in FIGS. 3A and 3B is in the front of the bracket (11) and the impact receiving element (13) is in the rear of the net (12).

With the embodiment of FIGS. 1A and 1B, the net (12) together with the impact receiving element (13) is provided in front of the bracket (11) so that the ball hit directly the impact receiving element (13) will be directly collected by the net (12). With the embodiment of FIGS. 3A and 3B, the net (12) is in front of the bracket (11) and the impact receiving element (13) is in the rear of the net (12). In order to accomplish the goal, the net (12) has a through hole (121) corresponding to the impact receiving element (13) so that the ball is able to pass through the through hole (121) of the net (12) and hit directly the impact receiving element (13).

With the embodiment of FIGS. 3A and 3B, the net (12) is provided in the front of the impact receiving element (13) so that the ball hit the impact receiving element (13) falls directly on the ground and the ball hit an area other than the impact receiving element (13) will be collected by the net (12).

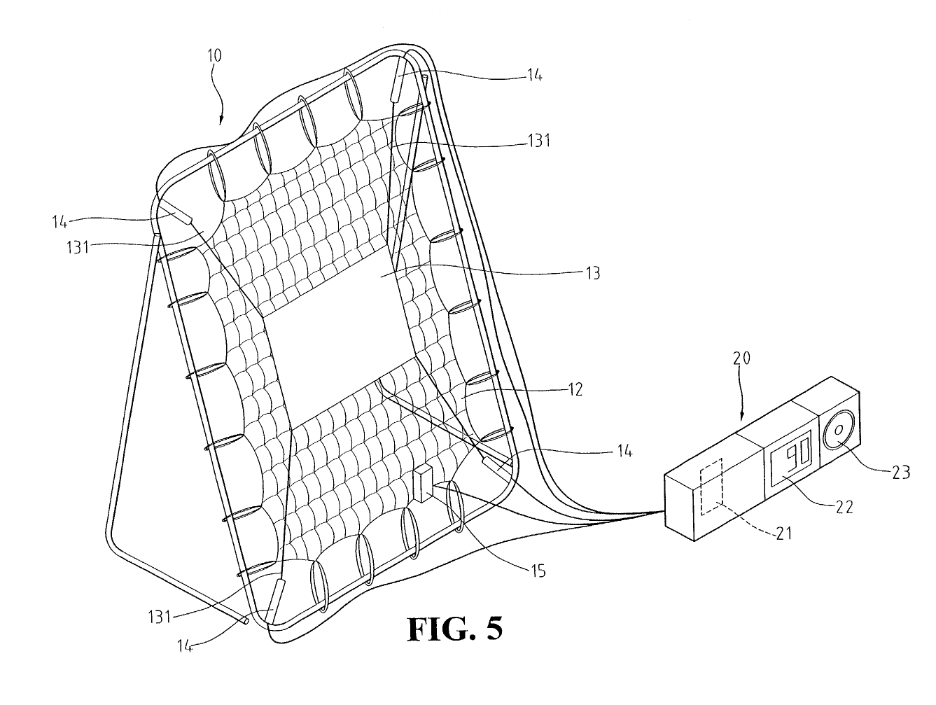

With reference to FIG. 5, it is to be noted that vibration sensors (15) are provided on the net (12) to enhance the detection of the impact of the ball and at least one speaker (23) is provided to send out the prerecorded voice to indicate whether the ball is valid or invalid.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A ball speed detecting assembly comprising:
a detecting device consisting of:
a bracket adapted to firmly stand on the ground and having an opening;
a net securely connected to the bracket to cover the opening; and
an impact receiving element securely connected to the bracket by sensors which are secured to corners of the bracket so that the sensors are able to detect the impact of the ball which hits the impact receiving element; and
a displaying device consisting of:
a microprocessor electrically connected with the sensors and having data prestored in the microprocessor for matching the impact of the ball; and
at least one speaker electrically connected with the microprocessor for sounding according to a signal from the microprocessor.

2. The ball speed detecting assembly as claimed in claim 1, wherein the net is equipped with vibration sensors.

3. The ball speed detecting assembly as claimed in claim 1, wherein the net is behind the impact receiving element.

4. The ball speed detecting assembly as claimed in claim 1, wherein the net is in front of the impact receiving element and has a through hole corresponding to the impact receiving element.

5. The ball speed detecting assembly as claimed in claim 1, wherein the impact receiving element is a fabric.

6. The ball speed detecting assembly as claimed in claim 2, wherein the impact receiving element is a fabric.

7. The ball speed detecting assembly as claimed in claim 3, wherein the impact receiving element is a fabric.

8. The ball speed detecting assembly as claimed in claim 4, wherein the impact receiving element is a fabric.
